(19) United States
(12) Patent Application Publication
(10) Pub. No.: US 2013/0053177 A1
(43) Pub. Date: Feb. 28, 2013

(54) RESIN COMPOSITION FOR GOLF BALL AND GOLF BALL

(71) Applicant: Takahiro SHIGEMITSU, Kobe-shi (JP)

(72) Inventor: Takahiro SHIGEMITSU, Kobe-shi (JP)

(21) Appl. No.: 13/596,145

(22) Filed: Aug. 28, 2012

(30) Foreign Application Priority Data
Aug. 29, 2011 (JP) 2011-186433

(51) Int. Cl. C08L 33/02; C08L 33/06; C08K 5/20; A63B 37/00; A63B 37/02

(52) U.S. Cl. 473/371; 473/351; 524/230

(57) ABSTRACT

A resin composition for a golf ball which has excellent resilience performance and fluidity provides for a golf ball that exhibits excellent shot feeling and excellent resilience performance. The resin composition includes (A) a resin component containing at least one selected from (a-1) a binary copolymer of an olefin and a C3-C8 α,β-unsaturated carboxylic acid, (a-2) a metal ion-neutralized product of a binary copolymer of an olefin and a C3-C8 α,β-unsaturated carboxylic acid, (a-3) a ternary copolymer of an olefin, a C3-C8 α,β-unsaturated carboxylic acid, and an α,β-unsaturated carboxylic acid ester, and (a-4) a metal ion-neutralized product of a ternary copolymer of an olefin, a C3-C8 α,β-unsaturated carboxylic acid, and an α,β-unsaturated carboxylic acid ester; and (B) a fatty acid amide. The fatty acid amide is present in an amount of 5 to 50 parts by mass per 100 parts by mass of the resin component.

### TECHNICAL FIELD

The present invention relates to a resin composition for a golf ball and a golf ball produced using the resin composition.

### BACKGROUND ART

Golf balls of various structures have been proposed such as one-piece golf balls which consist of a golf ball body, two-piece golf balls having a core and a cover, three-piece golf balls which have a core including a center and a single intermediate layer covering the center and a cover covering the core, and multi-piece golf balls which have a core including a center and at least two intermediate layers covering the center and a cover covering the core.

Ionomer resins are used as materials for golf balls, and are widely used as materials for intermediate layers or covers of golf balls because the resins provide high rigidity to golf balls and increase the flight distance thereof. Although it is known that ionomer resins having an increased degree of neutralization improve resilience performance, it is difficult to mold ionomer resins having a high degree of neutralization into intermediate layers or covers due to their low fluidity. Additionally, a higher degree of neutralization leads to a poorer shot feeling and a poorer overall feeling, although the resilience performance is improved.

In this context, techniques to improve the fluidity of an ionomer resin having a high degree of neutralization have been proposed such as addition of a low-molecular-weight material such as a fatty acid, a fatty acid derivative, an acid-modified olefin, or wax. These techniques, however, cause some problems such as smoking during molding and poor adhesion to a paint layer due to bleeding of a low-molecular-weight component. Another problem is that although a large amount of a low-molecular-weight material such as a fatty acid is required to ensure both resilience performance and fluidity, such an amount reduces material strength, thereby reducing the durability of a golf ball.

For example, Patent Literature 1 teaches that COR is improved by a material constituting the core or the like of a golf ball in which a metal salt of stearic acid has been added to an ionomeric polymer. Patent Literature 2 teaches that the shot feeling, moldability, resilience performance, and paint adhesion are all improved by a cover material of a golf ball in which a ternary ionomer resin is combined with a metal soap obtained by neutralizing an organic acid (e.g. stearic acid, palmitic acid) with a mono- to trivalent metal ion.

Patent Literatures 3 and 4 teach that cover materials of golf balls, which have good resilience performance and softness and also provide significant cost savings, are produced by adding a metal salt of a fatty acid (e.g. a metal salt of stearic acid) to an ionomer resin that consists of a reaction product of an olefin having 2 to 8 carbon atoms and an unsaturated monocarboxylic acid having 3 to 8 carbon atoms. Patent Literature 5 teaches a golf ball having an enhanced bend elastic constant which contains an ionomer composition modified with a nucleator such as an aliphatic monobasic or dibasic acid (e.g. c-endo-bicyclo[2.2.1]heptane-2,3-dicarboxylic acid).

These materials, however, have the above problems such as smoking during molding and poor adhesion to a paint layer because they contain a fatty acid or a derivative thereof. Additionally, there is still a need for improving resilience performance, shot feeling, and fluidity in a good balance.

### CITATION LIST

### Patent Literature

Patent Literature 1: JP-B 4173558
Patent Literature 2: JP-B 3402227
Patent Literature 3: U.S. Pat. No. 5,312,857
Patent Literature 4: U.S. Pat. No. 5,306,760
Patent Literature 5: JP-A 2006-346453

### SUMMARY OF INVENTION

### Technical Problem

An object of the present invention is to solve the above problems and provide a resin composition for a golf ball which has excellent resilience performance and fluidity. Another object is to provide a golf ball that gives an excellent shot feeling and has excellent resilience performance.

### Solution to Problem

The present invention relates to a resin composition for a golf ball which includes:

(A) a resin component containing at least one selected from the group consisting of (a-1) a binary copolymer of an olefin and an α,β-unsaturated carboxylic acid having 3 to 8 carbon atoms, (a-2) a metal ion-neutralized product of a binary copolymer of an olefin and an α,β-unsaturated carboxylic acid having 3 to 8 carbon atoms, (a-3) a ternary copolymer of an olefin, an α,β-unsaturated carboxylic acid having 3 to 8 carbon atoms, and an α,β-unsaturated carboxylic acid ester, and (a-4) a metal ion-neutralized product of a ternary copolymer of an olefin, an α,β-unsaturated carboxylic acid having 3 to 8 carbon atoms, and an α,β-unsaturated carboxylic acid ester; and

(B) a fatty acid amide, the fatty acid amide being present in an amount of 5 to 50 parts by mass per 100 parts by mass of the resin component.

Preferably, the fatty acid amide has 8 to 60 carbon atoms.

Preferably, the fatty acid amide is at least one of a saturated fatty acid amide and an unsaturated fatty acid amide.

Preferably, the fatty acid amide is at least one of a monoamide and a bisamide.

Preferably, the fatty acid amide is at least one selected from the group consisting of decanoic acid amide, lauric acid amide, stearic acid amide, behenic acid amide, oleic acid amide, erucic acid amide, ethylenebisstearic acid amide, and ethylenebisoleic acid amide.

Preferably, the resin composition for a golf ball has a slab hardness ranging from 15 to 70 in Shore D hardness.

Preferably, the fatty acid amide is represented by the following formula (1):

R¹—CO—NH—R² (1)

wherein R¹ and R², which may be the same or different, are each a saturated or unsaturated aliphatic hydrocarbon group having 8 to 30 carbon atoms, R² may be hydrogen, and part of the hydrogen atoms of R¹ and R² may be substituted by hydroxyl groups.

Preferably, the fatty acid amide is represented by the following formula (2) or (3):

R³—CO—NH-A¹-NH—CO—R⁴ (2)

R⁵—NH—CO-A²-CO—NH—R⁶ (3)

wherein R³, R⁴, R⁵, and R⁶, which may be the same or different, are each a saturated or unsaturated aliphatic hydrocarbon group having 8 to 30 carbon atoms, and A¹ and A², which may be the same or different, are each an alkylene group having 1 to 10 carbon atoms, a phenylene group, or an alkylphenylene group having 7 to 10 carbon atoms (divalent hydrocarbon group), wherein in the case of the alkylphenylene group, the group may be a divalent hydrocarbon group formed by combining a phenylene group and two or more groups selected from alkyl groups and alkylene groups; and part of the hydrogen atoms of the hydrocarbon groups of R³, R⁴, R⁵, R⁶, A¹, and A² may be substituted by hydroxyl groups.

Preferably, the fatty acid amide is a monoamide of formula (1) wherein R¹ is a saturated or unsaturated aliphatic hydrocarbon group and R² is hydrogen.

Preferably, the fatty acid amide is a monoamide of formula (1) wherein R¹ is an unsaturated aliphatic hydrocarbon group and R² is hydrogen.

Preferably, the resin composition for a golf ball has a melt flow rate (190° C./2.16 kg) of at least 0.01 g/10 min but not more than 100 g/10 min.

Preferably, the resin composition for a golf ball has a rebound resilience of not less than 25%.

The present invention also relates to a golf ball including a member made from the resin composition for a golf ball.

The present invention also relates to a golf ball having a core including one or more layers and a cover covering the core, wherein at least one of the layers of the core is made from the resin composition for a golf ball.

The present invention also relates to a multi-piece golf ball which has a core including a center and one or more intermediate layers covering the center, and a cover covering the core, wherein at least one of the intermediate layers is made from the resin composition for a golf ball.

The present invention further relates to a one-piece golf ball including a golf ball body made from the resin composition for a golf ball.

### Advantageous Effects of Invention

The present invention provides a resin composition for a golf ball which has excellent resilience performance and fluidity owing to the use of a specific resin in combination with a fatty acid amide. In addition, by using the resin composition, it is possible to provide a golf ball that gives an excellent shot feeling and has excellent resilience performance.

### DESCRIPTION OF EMBODIMENTS

The resin composition for a golf ball of the present invention contains: (A) at least one selected from the group consisting of (a-1) a binary copolymer of an olefin and an α,β-unsaturated carboxylic acid having 3 to 8 carbon atoms, (a-2) a metal ion-neutralized product of a binary copolymer of an olefin and an α,β-unsaturated carboxylic acid having 3 to 8 carbon atoms, (a-3) a ternary copolymer of an olefin, an α,β-unsaturated carboxylic acid having 3 to 8 carbon atoms, and an α,β-unsaturated carboxylic acid ester, and (a-4) a metal ion-neutralized product of a ternary copolymer of an olefin, an α,β-unsaturated carboxylic acid having 3 to 8 carbon atoms, and an α,β-unsaturated carboxylic acid ester; and (B) a fatty acid amide.

As described above, it is difficult to ensure both fluidity and resilience performance of materials for a golf ball which contain an ionomer resin or the like. However, addition of a specific component, i.e., a fatty acid amide, to a resin component such as an ionomer resin enables to improve fluidity while maintaining resilience performance. Thus, both of these properties can be ensured. Additionally, it is possible to avoid problems caused when a fatty acid or a fatty acid metal salt is added (e.g. smoking during molding, reduction in paint adhesion due to bleeding in the painting on the body of a golf ball, reduction in the durability of a golf ball due to reduced material strength).

Additionally, the addition of a fatty acid amide to an ionomer resin or the like ensures flexibility of the material while suppressing the reduction of resilience performance. Therefore, both a good shot feeling and resilience performance of a golf ball can be ensured. Thus, it is possible to improve fluidity and therefore moldability while suppressing the reduction of resilience performance, and also to improve the performance in terms of shot feeling due to flexibility of the material. Accordingly, the present invention provides a resin composition for a golf ball and a golf ball which improve in resilience performance, fluidity, and shot feeling in a good balance.

First, the components (a-1) to (a-4) usable in the resin component (A) in the present invention are described.

The component (a-1) is a binary copolymer of an olefin and an α,β-unsaturated carboxylic acid having 3 to 8 carbon atoms, and is nonionic because the carboxyl groups of the copolymer are not neutralized. The component (a-2) is a metal ion-neutralized product of a binary copolymer of an olefin and an α,β-unsaturated carboxylic acid having 3 to 8 carbon atoms. Examples thereof include ionomer resins obtained by neutralizing at least part of the carboxyl groups of such a copolymer with a metal ion.

The component (a-3) is a ternary copolymer of an olefin, an α,β-unsaturated carboxylic acid having 3 to 8 carbon atoms, and an α,β-unsaturated carboxylic acid ester, and is nonionic because the carboxyl groups of the copolymer are not neutralized. The component (a-4) is a metal ion-neutralized product of a ternary copolymer of an olefin, an α,β-unsaturated carboxylic acid having 3 to 8 carbon atoms, and an α,β-unsaturated carboxylic acid ester. Examples thereof include ionomer resins obtained by neutralizing at least part of the carboxyl groups of such a copolymer with a metal ion.

In the present invention, the “binary copolymer (a-1) of an olefin and an α,β-unsaturated carboxylic acid having 3 to 8 carbon atoms” may also be referred to simply as the “binary copolymer”; the “ionomer resin consisting of (a-2) a metal ion-neutralized product of a binary copolymer of an olefin and an α,β-unsaturated carboxylic acid having 3 to 8 carbon atoms” may also be referred to as the “binary ionomer resin”; the “ternary copolymer (a-3) of an olefin, an α,β-unsaturated carboxylic acid having 3 to 8 carbon atoms, and an α,β-unsaturated carboxylic acid ester” may also be referred to simply as the “ternary copolymer”; and the “ionomer resin consisting of (a-4) a metal ion-neutralized product of a ternary copolymer of an olefin, an α,β-unsaturated carboxylic acid having 3 to 8 carbon atoms, and an α,β-unsaturated carboxylic acid ester” may also be referred to as the “ternary ionomer resin”.

The olefin in the component (a-1) to (a-4) is preferably an olefin having 2 to 8 carbon atoms. Examples thereof include ethylene, propylene, butene, pentene, hexene, heptene, and octene. Particularly, ethylene is preferred. Examples of the α,β-unsaturated carboxylic acid having 3 to 8 carbon atoms include acrylic acid, methacrylic acid, fumaric acid, maleic acid, and crotonic acid. Particularly, acrylic acid and methacrylic acid are preferred. Examples of the α,β-unsaturated carboxylic acid ester include methyl, ethyl, propyl, n-butyl and isobutyl esters of acrylic acid, methacrylic acid, fumaric acid, maleic acid and the like. Particularly, acrylic acid esters and methacrylic acid esters are preferred.

Preferred examples of the binary copolymer (a-1) include binary copolymers of ethylene and (meth)acrylic acid, and preferred examples of the binary ionomer resin (a-2) include metal ion-neutralized products of binary copolymers of ethylene and (meth)acrylic acid. Preferred examples of the ternary copolymer (a-3) include ternary copolymers of ethylene, (meth)acrylic acid, and a (meth)acrylic acid ester, and preferred examples of the ternary ionomer resin (a-4) include metal ion-neutralized products of ternary copolymers of ethylene, (meth)acrylic acid, and a (meth)acrylic acid ester. The term “(meth)acrylic acid” herein means acrylic acid and/or methacrylic acid.

The amount of units of the α,β-unsaturated carboxylic acid having 3 to 8 carbon atoms in the binary copolymer (a-1) or the ternary copolymer (a-3) is preferably not less than 4% by mass, and more preferably not less than 5% by mass. Also, the amount is preferably not more than 30% by mass, and more preferably not more than 25% by mass.

The binary copolymer (a-1) or the ternary copolymer (a-3) preferably has a melt flow rate (190° C., 2.16 kg load) of not less than 0.1 g/10 min, more preferably not less than 0.5 g/10 min, and still more preferably not less than 1 g/10 min. Also, the melt flow rate is preferably not more than 1700 g/10 min, more preferably not more than 1500 g/10 min, and still more preferably not more than 1300 g/10 min. When the melt flow rate is not less than 0.1 g/10 min, the resin composition for a golf ball has good fluidity and therefore is readily molded into a member of a golf ball. When the melt flow rate is not more than 1700 g/10 min, a golf ball having better durability can be obtained.

Specific examples of commercial products (indicated by trade name) of the binary copolymer (a-1) include ethylene-methacrylic acid copolymers sold by Du Pont-Mitsui Polychemicals Co., Ltd. under the name of “NUCREL (registered trademark)” (e.g. “NUCREL N1050H”, “NUCREL N2050H”, “NUCREL N1110H”, “NUCREL N0200H”) and an ethylene-acrylic acid copolymer sold by The Dow Chemical Company under the name of “PRIMACOR (registered trademark) 59801”.

Specific examples of commercial products (indicated by trade name) of the ternary copolymer (a-3) include products sold by Du Pont-Mitsui Polychemicals Co., Ltd. under the name of “NUCREL (registered trademark)” (e.g. “NUCREL AN4318”, “NUCREL AN4319”), products sold by Du Pont under the name of “NUCREL (registered trademark)” (e.g. “NUCREL AE”), and products sold by The Dow Chemical Company under the name of “PRIMACOR (registered trademark)” (e.g. “PRIMACOR AT310”, “PRIMACOR AT320”). The binary copolymer (a-1) or ternary copolymer (a-3) may be only one species or may be a combination of two or more species.

The amount of units of the α,β-unsaturated carboxylic acid having 3 to 8 carbon atoms in the binary ionomer resin (a-2) is preferably not less than 4% by mass, more preferably not less than 5% by mass, and still more preferably not less than 8% by mass. Also, the amount is preferably not more than 30% by mass, and more preferably not more than 25% by mass. When the amount is not less than 4% by mass, a member having high resilience can be obtained. When the amount is not more than 30% by mass, a member having moderate hardness can be obtained and good durability and shot feeling can be achieved.

The degree of neutralization of the carboxyl groups of the binary ionomer resin (a-2) is preferably not less than 15 mol %, and more preferably not less than 20 mol %. When the degree of neutralization is not less than 15 mol %, a golf ball having good resilience performance and durability can be obtained. The upper limit of the degree of neutralization is not particularly limited and may be 100 mol %.

The degree of neutralization of the carboxyl groups of the binary ionomer resin (a-2) can be determined by the following equation:

Degree of neutralization of binary ionomer resin=100×[the number of moles of neutralized carboxyl groups of binary ionomer resin]/[the total number of moles of carboxyl groups of binary ionomer resin before neutralization].

Examples of metal ions usable for neutralizing at least part of the carboxyl groups of the binary ionomer resin (a-2) include ions of monovalent metals such as sodium, potassium, and lithium; ions of divalent metals such as magnesium, calcium, zinc, barium, and cadmium; ions of trivalent metals such as aluminum; and ions of other metals such as tin and zirconium.

Specific examples of commercial products (indicated by trade name) of the binary ionomer resin (a-2) include products sold by Du Pont-Mitsui Polychemicals Co., Ltd. under the name of “Himilan (registered trademark)” (e.g. Himilan 1555 (Na), Himilan 1557 (Zn), Himilan 1605 (Na), Himilan 1706 (Zn), Himilan 1707 (Na), Himilan AM 7311 (Mg), Himilan AM 7329 (Zn)). Other examples thereof include products sold by Du Pont under the name of “Surlyn (registered trademark)” (e.g. Surlyn 8945 (Na), Surlyn 9945 (Zn), Surlyn 8140 (Na), Surlyn 8150 (Na), Surlyn 9120 (Zn), Surlyn 9150 (Zn), Surlyn 6910 (Mg), Surlyn 6120 (Mg), Surlyn 7930 (Li), Surlyn 7940 (Li), Surlyn AD 8546 (Li)). Still other examples include commercially available ionomer resins from ExxonMobil Chemical Company such as “Iotek (registered trademark)” (e.g. Iotek 8000 (Na), Iotek 8030 (Na), Iotek 7010 (Zn), Iotek 7030 (Zn)). Na, Zn, Li, Mg and the like in the parentheses following the trade names refer to metal species of the metal ions for neutralization. The binary ionomer resin (a-2) may be only one of the above examples or may be a mixture of two or more of them.

The binary ionomer resin (a-2) preferably has a melt flow rate (190° C., 2.16 kg load) of not less than 0.1 g/10 min, more preferably not less than 0.5 g/10 min, and still more preferably not less than 1.0 g/10 min. The melt flow rate is preferably not more than 50 g/10 min, more preferably not more than 40 g/10 min, and still more preferably not more than 30 g/10 min. When the melt flow rate is not less than 0.1 g/10 min, the resin composition for a golf ball has good fluidity, and can be molded into, for example, a thin layer. When the melt flow rate is not more than 50 g/10 min, a golf ball having better durability can be obtained.

The binary ionomer resin (a-2) preferably has a slab hardness of not less than 40, more preferably not less than 45, and still more preferably not less than 50 in Shore D hardness. Also, the slab hardness (Shore D hardness) is preferably not more than 75, more preferably not more than 73, and still more preferably not more than 70. When the slab hardness is not less than 40, a member having high resilience can be obtained. When the slab hardness is not more than 75, a member having moderate hardness and therefore a golf ball having better durability can be obtained.

The amount of units of the α,β-unsaturated carboxylic acid having 3 to 8 carbon atoms in the ternary ionomer resin (a-4) is preferably not less than 2% by mass, and more preferably not less than 3% by mass. Also, the amount is preferably not more than 30% by mass, and more preferably not more than 25% by mass.

The degree of neutralization of the carboxyl groups of the ternary ionomer resin (a-4) is preferably not less than 20 mol %, and more preferably not less than 30 mol %. When the degree is not less than 20 mol %, a golf ball having good resilience performance and durability can be produced using the resin composition for a golf ball. The upper limit of the degree of neutralization is not particularly limited and may be 100 mol %.

Here, the degree of neutralization of the carboxyl groups of the ternary ionomer resin (a-4) can be determined by the following equation:

Degree of neutralization of ternary ionomer resin=100×[the number of moles of neutralized carboxyl groups of ternary ionomer resin]/[the total number of moles of carboxyl groups of ternary ionomer resin before neutralization].

Examples of metal ions usable for neutralizing at least part of the carboxyl groups of the ternary ionomer resin (a-4) include the same ions as the above-listed ones usable for the binary ionomer resin (a-2). The ternary ionomer resin (a-4) is preferably one neutralized with magnesium ions. The use of one neutralized with magnesium ions increases rebound resilience.

Specific examples of commercial products (indicated by trade name) of the ternary ionomer resin (a-4) include products sold by Du Pont-Mitsui Polychemicals Co., Ltd. under the name of “Himilan (registered trademark)” (e.g. Himilan AM 7327 (Zn), Himilan 1855 (Zn), Himilan 1856 (Na), Himilan AM 7331 (Na)). Other examples include commercially available ternary ionomer resins from Du Pont such as Surlyn 6320 (Mg), Surlyn 8120 (Na), Surlyn 8320 (Na), Surlyn 9320 (Zn), Surlyn 9320W (Zn), HPF 1000 (Mg), and HPF 2000 (Mg). Further examples include commercially available ternary ionomer resins from ExxonMobil Chemical Company such as Iotek 7510 (Zn) and Iotek 7520 (Zn). Na, Zn, Mg and the like in the parentheses following the trade names refer to metal species of the metal ions for neutralization. The ternary ionomer resin (a-4) may be only one species or may be a combination of two or more species.

The ternary ionomer resin (a-4) preferably has a melt flow rate (190° C., 2.16 kg load) of not less than 0.1 g/10 min, more preferably not less than 0.3 g/10 min, and still more preferably not less than 0.5 g/10 min. Also, the melt flow rate is preferably not more than 20 g/10 min, more preferably not more than 15 g/10 min, and still more preferably not more than 10 g/10 min. When the melt flow rate is not less than 0.1 g/10 min, the resin composition for a golf ball has good fluidity and can be readily molded into a thin layer. When the melt flow rate is not more than 20 g/10 min, a golf ball having better durability can be obtained.

The ternary ionomer resin (a-4) preferably has a slab hardness of not less than 20, more preferably not less than 25, and still more preferably not less than 30 in Shore D hardness. Also, the slab hardness (Shore D hardness) is preferably not more than 70, more preferably not more than 65, and still more preferably not more than 60. When the slab hardness is not less than 20, a member having moderate softness and therefore a golf ball having good resilience performance can be obtained. When the slab hardness is not more than 70, a member having moderate hardness and therefore a golf ball having better durability can be obtained.

The resin composition for a golf ball of the present invention preferably contains the ternary copolymer (a-3) or the ternary ionomer resin (a-4) as the resin component (A). In this case, a member having moderate hardness can be obtained and high resilience performance can be achieved.

Although in a preferred aspect, the resin component of the resin composition for a golf ball of the present invention consists only of at least one selected from the above-described components (a-1) to (a-4), the resin component may contain other thermoplastic elastomer(s) and/or thermoplastic resin(s) as long as the effects of the present invention are not impaired. In the case that the resin component contains other thermoplastic elastomer(s) and/or thermoplastic resin(s), the total amount of the components (a-1) to (a-4) is preferably not less than 50% by mass, more preferably not less than 60% by mass, and still more preferably not less than 70% by mass of the resin component.

Next, the fatty acid amide (B) used in the present invention is described.

The “fatty acid amide” refers to an amide compound formed from a fatty acid and an amine, and examples thereof include monoamides having a single amide group (e.g. saturated/unsaturated monoamides, substituted amides, methylolamides, ethanolamides, ester amides, substituted ureas), bisamides having two amide groups (e.g. saturated/unsaturated bisamides, aromatic bisamides), and triamides having three amide groups.

The number of carbon atoms of the fatty acid amide is preferably not less than 8, more preferably not less than 10, and still more preferably not less than 12 in order to prevent bleeding from occurring easily on the resin composition. In terms of flexibility, the number of carbon atoms is preferably not more than 60, more preferably not more than 58, and still more preferably not more than 56.

Examples of the fatty acid amide include compounds represented by the following formulas (1) to (3).

R¹—CO—NH—R² (1)

In the formula (1), R¹ and R², which may be the same or different, are each a saturated or unsaturated aliphatic hydrocarbon group having 8 to 30 carbon atoms, R² may be hydrogen, and part of the hydrogen atoms of R¹ and R² may be substituted by hydroxyl groups.

R³—CO—NH-A¹-NH—CO—R⁴ (2)

R⁵—NH—CO-A²-CO—NH—R⁶ (3)

In the formulas (2) and (3), R³, R⁴, R⁵, and R⁶, which may be the same or different, are each a saturated or unsaturated aliphatic hydrocarbon group having 8 to 30 carbon atoms, and A¹ and A², which may be the same or different, are each an alkylene group having 1 to 10 carbon atoms, a phenylene group, or an alkylphenylene group having 7 to 10 carbon atoms (divalent hydrocarbon group), wherein in the case of the alkylphenylene group, the group may be a divalent hydrocarbon group formed by combining a phenylene group and two or more groups selected from alkyl groups and alkylene groups; and part of the hydrogen atoms of the hydrocarbon groups of R³, R⁴, R⁵, R⁶, A¹, and A² may be substituted by hydroxyl groups.

The number of carbon atoms of R¹ or R² in the monoamide represented by the formula (1) is preferably 10 to 28. Monoamides of the formula wherein R¹ is a saturated or unsaturated aliphatic hydrocarbon group and R² is hydrogen are preferred, and monoamides of the formula wherein R¹ is an unsaturated aliphatic hydrocarbon group and R² is hydrogen are more preferred. In these cases, it is possible to ensure high levels of both fluidity and resilience performance of the resin composition as well as high levels of both shot feeling and resilience performance of the golf ball.

Specific examples of the monoamide include saturated fatty acid amides such as decanoic acid amide, lauric acid amide, palmitic acid amide, stearic acid amide, behenic acid amide, and hydroxystearic acid amide; unsaturated fatty acid amides such as oleic acid amide and erucic acid amide; and substituted amides formed from saturated or unsaturated long-chain fatty acids and long-chain amines, such as stearyl stearic acid amide, oleyl oleic acid amide, oleyl stearic acid amide, and stearyl oleic acid amide.

The number of carbon atoms of R³, R⁴, R⁵, or R⁶ in the bisamide represented by the formula (2) or (3) is preferably 10 to 28. A¹ and A² are each preferably an alkylene group. In this case, it is possible to ensure high levels of both fluidity and resilience performance of the resin composition as well as high levels of both shot feeling and resilience performance of the golf ball.

Specific examples of the bisamides include ethylenebisstearic acid amide, ethylenebisisostearic acid amide, ethylenebisoleic acid amide, methylenebislauric acid amide, hexamethylenebisoleic acid amide, hexamethylenebishydroxystearic acid amide, m-xylylenebisstearic acid amide, and N,N′-bisstearyl sebacic acid amide.

The amount of the fatty acid amide (B) is not less than 5 parts by mass, preferably not less than 6 parts by mass, and more preferably not less than 7 parts by mass, per 100 parts by mass of the resin component. The amount is not more than 50 parts by mass, preferably not more than 45 parts by mass, and more preferably not more than 40 parts by mass. When the amount is in the above range, it is possible to improve fluidity while suppressing the reduction of resilience performance and to ensure flexibility as well.

The resin composition for a golf ball of the present invention may further contain (C) a basic inorganic metal compound. The basic inorganic metal compound (C) is optionally added to neutralize unneutralized carboxyl groups of the component (A). Examples of the basic inorganic metal compound (C) include metal elements such as sodium, lithium, potassium, calcium, and magnesium; metal hydroxides such as magnesium hydroxide, calcium hydroxide, sodium hydroxide, lithium hydroxide, potassium hydroxide, and copper hydroxide; metal oxides such as magnesium oxide, calcium oxide, zinc oxide, and copper oxide; and metal carbonates such as magnesium carbonate, calcium carbonate, sodium carbonate, lithium carbonate, and potassium carbonate. Any of these basic inorganic metal compounds (C) may be used alone, or two or more of these may be used in combination. Among these, the basic inorganic metal compound (C) is preferably magnesium hydroxide, calcium hydroxide, sodium carbonate, lithium carbonate, potassium carbonate, zinc oxide, or copper oxide.

The amount of the basic inorganic metal compound (C) is preferably more than 0 parts by mass, and more preferably not less than 1 part by mass, per 100 parts by mass of the resin component. The amount is preferably not more than 10 parts by mass, and more preferably not more than 9 parts by mass. If the amount is too small, only a small amount of ionic associations are present, resulting in low resilience. Conversely, if the amount is too large, the ionic associations may not be finely dispersed, resulting in low resilience.

The resin composition for a golf ball of the present invention may further contain additives such as a pigment (e.g. white pigments such as titanium oxide, blue pigments), a weighting agent, a dispersant, an antioxidant, a UV absorbent, a photostabilizer, a fluorescent material, and a fluorescent brightener, as long as the performance of the golf ball is not impaired. Furthermore, the resin composition for a golf ball of the present invention may further contain, for example, a fatty acid and/or a metal salt thereof as long as the effects of the present invention are not impaired. However, it is preferable not to use together low-molecular-weight materials such as a fatty acid and/or a metal salt thereof because they may reduce the mechanical properties and the like.

The amount of the white pigment (e.g. titanium oxide) is preferably not less than 0.5 parts by mass, and more preferably not less than 1 part by mass, per 100 parts by mass of the resin component. The amount is preferably not more than 10 parts by mass, and more preferably not more than 8 parts by mass. When the amount is not less than 0.5 parts by mass, it is possible to impart hiding properties to a golf ball member to be produced. Conversely, the use of more than 10 parts by mass of the white pigment may reduce the durability of a golf ball to be produced.

The resin composition for a golf ball of the present invention can be prepared, for example, by dry-blending the component (A), the component (B), and optionally the component (C). The dry-blended mixture may be pelletized by extrusion. For the dry-blending, for example, a mixer capable of blending material pellets is preferably used, and a tumbler mixer is more preferably used. For the extrusion, a known extruder such as a single-screw extruder, a twin-screw extruder, or a twin-screw/single-screw extruder can be used.

The resin composition for a golf ball of the present invention preferably has a melt flow rate (190° C./2.16 kg) of not less than 0.01 g/10 min, more preferably not less than 0.05 g/10 min, and still more preferably not less than 0.1 g/10 min. The melt flow rate is preferably not more than 100 g/10 min, more preferably not more than 80 g/10 min, and still more preferably not more than 50 g/10 min. When the melt flow rate is in the above range, the moldability for forming a member of a golf ball is good.

The resin composition for a golf ball preferably has a rebound resilience of not less than 25%, more preferably not less than 30%, and still more preferably not less than 32%. When the resin composition for a golf ball having a rebound resilience of not less than 25% is used, a golf ball having excellent resilience performance (flight distance) can be obtained. The rebound resilience is determined by molding the resin composition for a golf ball into a sheet and measuring the sheet by a measuring method described below.

The resin composition for a golf ball preferably has a slab hardness of not less than 15, more preferably not less than 20, and still more preferably not less than 25 in Shore D hardness. The slab hardness (Shore D hardness) is preferably not more than 70, more preferably not more than 65, still more preferably not more than 60, and most preferably not more than 50. When the resin composition for a golf ball having a slab hardness of not less than 15 is used, a golf ball having excellent resilience performance (flight distance) can be obtained. In addition, when the resin composition for a golf ball having a slab hardness of not more than 70 is used, a golf ball having excellent durability can be obtained. Here, the slab hardness of the resin composition for a golf ball is determined by molding the resin composition for a golf ball into a sheet and measuring the sheet by a method described below.

The golf ball of the present invention is not particularly limited, provided that it includes a member made from the resin composition for a golf ball. The present invention encompasses, for example, one-piece golf balls; two-piece golf balls having a single-layer core and a cover covering the single-layer core; three-piece golf balls which have a core including a center and a single intermediate layer covering the center and a cover covering the core; and multi-piece golf balls (including the three-piece golf balls) which have a core including a center and one or more intermediate layers covering the center and a cover covering the core, provided that any of members of these golf balls is made from the resin composition for a golf ball of the present invention. Among these, preferred are golf balls which have a core including one or more layers and a cover covering the core and in which at least one of the layers of the core is made from the resin composition for a golf ball, and one-piece golf balls in which the golf ball body is made from the resin composition for a golf ball. In particular, preferred are two-piece golf balls which have a single-layer core and a cover covering the single-layer core and in which the single-layer core is made from the resin composition for a golf ball, and multi-piece golf balls which have a core including a center and one or more intermediate layers covering the center and a cover covering the core and in which the center is made from the resin composition for a golf ball.

The following describes an example of the golf ball of the present invention that is a two-piece golf ball which has a core and a cover covering the core and in which the core is made from the resin composition for a golf ball. However, the scope of the present invention is not limited to this example.

The core can be formed, for example, by injection-molding the resin composition for a golf ball. Specifically, the core is preferably formed by melting the resin composition for a golf ball by heating to 160° C. to 260° C., injecting the molten resin composition into a mold clamped under a pressure of 1 to 100 MPa in 1 to 100 seconds, cooling the resin composition for 30 to 300 seconds, and opening the mold.

Preferably, the core is spherical in shape. If the core is not spherical, the cover is likely to have a non-uniform thickness and therefore some parts thereof may have reduced covering performance.

The diameter of the core is preferably not less than 39.00 mm, more preferably not less than 39.25 mm, and still more preferably not less than 39.50 mm. The diameter is preferably not more than 42.37 mm, more preferably not more than 42.22 mm, and still more preferably not more than 42.07 mm. When the diameter is not less than 39.00 mm, the cover layer is not too thick, thereby providing good resilience performance. In addition, when the diameter is not more than 42.37 mm, the cover layer is not too thin, thereby allowing the cover to provide sufficient protection.

In the case that the core has a diameter ranging from 39.00 to 42.37 mm, the amount of compression deformation (shrink in the compression direction) of the core as determined by applying a load from 98 N as an initial load to 1275 N as a final load is preferably not less than 1.00 mm, and more preferably not less than 1.10 mm. The amount of compression deformation is preferably not more than 5.00 mm, more preferably not more than 4.90 mm, and still more preferably not more than 4.80 mm. When the amount of compression deformation is not less than 1.00 mm, a good shot feeling is ensured. In addition, when the amount of compression deformation is not more than 5.00 mm, good resilience performance is ensured.

The core preferably has a surface hardness of not less than 20, more preferably not less than 25, and still more preferably not less than 30 in Shore D hardness. The surface hardness (Shore D hardness) is preferably not more than 70, and more preferably not more than 69. When the surface hardness is not less than 20, the core has moderate softness, thereby providing good resilience performance. In addition, when the surface hardness is not more than 70, the core has moderate hardness, thereby providing a good shot feeling.

The core preferably has a central hardness of not less than 20, more preferably not less than 22, and still more preferably not less than 24 in Shore D hardness. If the central hardness is less than 20, the core may be too soft, thereby resulting in poor resilience performance. Also, the core preferably has a central hardness of not more than 50, more preferably not more than 48, and still more preferably not more than 46 in Shore D hardness. If the central hardness is more than 50, the core is likely to be too hard, thereby resulting in a poor shot feeling. In the present invention, the central hardness of a core is determined by cutting the core into two halves and measuring the halves at the central point of the cut plane with a spring type Shore D hardness tester.

In one preferred aspect, the core contains a filler. The filler is added mainly as a weighting agent in order to adjust the density of a golf ball obtained as the final product in the range of 1.0 to 1.5, and may be added as required. Examples of the filler include inorganic fillers such as zinc oxide, barium sulfate, calcium carbonate, magnesium oxide, tungsten powder, and molybdenum powder. The amount of the filler is preferably not less than 0.5 parts by mass, and more preferably not less than 1.0 part by mass, per 100 parts by mass of the resin component. The amount is preferably not more than 30 parts by mass, and more preferably not more than 20 parts by mass. If the amount is less than 0.5 parts by mass, it is difficult to adjust the weight. Conversely, if the amount is more than 30 parts by mass, the weight fraction of the resin component may be small and the resilience performance tends to be lowered.

The cover of the golf ball of the present invention is preferably made from a composition for a cover containing a resin component. Examples of resins that may be contained in the resin component include various resins such as ionomer resins, polyester resins, urethane resins (e.g. thermoplastic urethane resins, two-component curing type urethane resins), and polyamide resins; and thermoplastic polyamide elastomers sold by Arkema under the name of “Pebax (registered trademark)” (e.g. “Pebax 2533”), thermoplastic polyester elastomers sold by Du Pont-Toray Co., Ltd. under the name of “Hytrel (registered trademark)” (e.g. “Hytrel 3548”, “Hytrel 4047”), thermoplastic polyurethane elastomers sold by BASF Japan Ltd. under the name of “Elastollan (registered trademark)” (e.g. “Elastollan XNY97A”), and thermoplastic styrene elastomers sold by Mitsubishi Chemical Corporation under the name of “Rabalon (registered trademark)”. Any of these resins may be used alone, or two or more of these may be used as a blend.

Preferred examples of ionomer resins usable for the cover of the golf ball include those listed for the components (a-2) and (a-4).

The composition for a cover used for the cover of the golf ball more preferably contains a polyurethane resin (e.g. a polyurethane elastomer) or ionomer resin as the resin component. The polyurethane resin or ionomer resin preferably constitutes not less than 50% by mass, more preferably not less than 60% by mass, and still more preferably not less than 70% by mass, of the resin component of the composition for a cover.

The composition for a cover may further contain additives such as a pigment (e.g. white pigments such as titanium oxide, blue pigments, red pigments), a weighting agent (e.g. zinc oxide, calcium carbonate, barium sulfate), a dispersant, an antioxidant, a UV absorbent, a photostabilizer, a fluorescent material, and a fluorescent brightener in addition to the resin component, as long as the cover quality is not impaired.

The amount of the white pigment (e.g. titanium oxide) is preferably not less than 0.5 parts by mass, and more preferably not less than 1 part by mass, per 100 parts by mass of the resin component of the cover. The amount is preferably not more than 10 parts by mass, and more preferably not more than 8 parts by mass. When the amount is not less than 0.5 parts by mass, it is possible to impart hiding properties to the cover. If the amount is more than 10 parts by mass, the durability of the resulting cover may be reduced.

The cover of the golf ball of the present invention can be formed, for example, by methods such as a compression-molding method which includes molding the composition for a cover into hollow shells, covering the core with the plurality of hollow shells, and compression-molding the covered core (preferably, a method which includes molding the composition for a cover into hollow half shells, covering the core with the two half shells, and compression-molding the covered core), and an injection-molding method which includes injection-molding the composition for a cover directly onto the core.

In the case that the cover is formed by injection-molding the composition for a cover, the composition for a cover may be pelletized by extrusion beforehand, and the pellets may be used for the injection-molding, or alternatively, the materials for a cover such as the base material (resin component) and a pigment may be dry-blended, and then directly injection-molded. For forming the cover, it is preferable to use upper and lower molds each having a hemispherical cavity with pimples a part of which also serve as retractable hold pins. In the case of forming the cover by injection-molding, the cover can be formed by protruding the hold pins, placing and holding the core with the hold pins, injecting the composition for a cover, and then cooling it. More specifically, it is preferable to perform the process by injecting the composition for a cover heated to 200° C. to 250° C. into a mold clamped under a pressure of 9 to 15 MPa in 0.5 to 5 seconds, cooling the composition for 10 to 60 seconds, and opening the mold.

In the case of forming a cover, indentations called “dimples” are usually formed on the surface. The total number of dimples on the cover is preferably 200 to 500. If the total number is less than 200, the effect of dimples is unlikely to be obtained. Conversely, if the total number exceeds 500, the effect of dimples is also unlikely to be obtained because the individual size of the dimples is small. Examples of the shape (shape in plan view) of the dimples include, but are not limited to, circles; polygonal shapes such as substantially triangular shapes, substantially quadrangular shapes, substantially pentagonal shapes, and substantially hexagonal shapes; and other irregular shapes. Any of these shapes may be employed solely, or two or more of these may be employed in combination.

The cover preferably has a thickness of not more than 2.0 mm, more preferably not more than 1.6 mm, still more preferably not more than 1.2 mm, and particularly preferably not more than 1.0 mm. When the thickness is not more than 2.0 mm, the resulting golf ball has better resilience performance and gives a better shot feeling. The cover preferably has a thickness of not less than 0.1 mm, more preferably not less than 0.2 mm, and still more preferably not less than 0.3 mm. If the thickness is less than 0.1 mm, it may be difficult to obtain the cover by molding, and the cover may have poor durability and abrasion resistance.

After the cover is formed, the golf ball body is taken out from the mold, and is preferably subjected to surface treatments such as deburring, cleaning, and sandblasting as necessary. If desired, a paint layer or a mark may be formed. The paint layer preferably has a thickness of, but not limited to, not less than 5 μm, and more preferably not less than 7 μm. The thickness of the paint layer is preferably not more than 25 μm, and more preferably not more than 18 μm. If the thickness is less than 5 μm, the paint layer is likely to be worn away by continued use of the golf ball. Conversely, if the thickness is more than 25 μm, the effect of dimples is likely to be reduced, resulting in reduction of the flying performance of the golf ball.

The amount of compression deformation (shrink in the compression direction) of the golf ball of the present invention as determined by applying a load from 98 N as an initial load to 1275 N as a final load is preferably not less than 2.0 mm, and more preferably not less than 2.2 mm. The amount of compression deformation is preferably not more than 4.0 mm, and more preferably not more than 3.5 mm. When the amount of compression deformation is not less than 2.0 mm, the golf ball has moderate hardness and gives a good shot feeling. In addition, when the amount of compression deformation is not more than 4.0 mm, high resilience performance is ensured.

Although the above description is offered to illustrate an example in which the resin composition for a golf ball of the present invention is used for a core, the resin composition for a golf ball of the present invention can also be used for centers, intermediate layers, and covers. In the case that a center is made from the resin composition for a golf ball of the present invention, for example, any materials listed above as the resin component for the cover may be used for intermediate layer(s).

### EXAMPLES

The following description is offered to specifically illustrate the present invention based on examples but the scope of the present invention is not limited only to these examples.

### [Evaluation]

### (1) Slab Hardness (Shore D Hardness)

Sheets having a thickness of about 2 mm were prepared from a resin composition for a golf ball by hot press molding and stored at 23° C. for two weeks. Three or more of the sheets were stacked on one another to avoid being affected by the measuring substrate or the like on which the sheets were placed, and the stack was measured using a P1 type auto hardness tester (from KOBUNSHI KEIKI CO., LTD.) including a spring type Shore D hardness tester as prescribed by ASTM-D2240.

(2) Melt Flow Rate (MFR) (g/10 Min)

The MFR was measured using a flow tester (Shimadzu flow tester CFT-100C manufactured by Shimadzu Corporation) in accordance with JIS K 7210. The measurement was conducted by applying a load of 2.16 kg at 190° C.

### (3) Rebound Resilience (%)

A sheet with a thickness of about 2 mm was prepared from a resin composition for a golf ball by hot press molding. Circular pieces having a diameter of 28 mm were punched out of this sheet, and six pieces were stacked to prepare a cylindrical specimen having a thickness of about 12 mm and a diameter of 28 mm. The specimens were subjected to the Lupke rebound resilience test (testing at temperature 23° C. and humidity 50RH %). The preparation of specimens and the testing method were based on JIS K 6255.

### (4) Amount of Compression Deformation (mm)

The amount of deformation in the compression direction (shrink in the compression direction) of a spherical specimen was measured by applying a load from 98 N as an initial load to 1275 N as a final load to the spherical specimen.

### (5) Coefficient of Restitution

A 198.4-g metal cylindrical object was allowed to collide with each spherical specimen (golf ball) at a speed of 40 m/sec, and the speeds of the cylindrical object and the golf ball before and after the collision were measured. Based on these speeds and the mass of each golf ball, the coefficient of restitution for the golf balls was calculated. The measurement was conducted by using twelve spherical specimens of each kind, and their average value was taken as the coefficient of restitution for the kind of spherical specimen in question.

### (6) Shot Feeling

An actual hitting test was carried out by ten amateur golfers (high skilled golfers) using a driver, and the shot feeling of each golf ball was evaluated according to the following criteria in terms of the golfers' feelings when they hit the ball. The evaluation grade given by the largest number of golfers among the ten golfers was determined as the shot feeling of the golf ball.

### Criteria for Grades

Good: Small impact and good feeling

Fair: Ordinary levels

Poor: Large impact and bad feeling

### [Production of Golf Ball]

### (1) Center Preparation 1

Each rubber composition for a center shown in Table 1 was kneaded and heat-pressed in upper and lower molds, each having a hemispherical cavity, at 170° C. for 15 minutes to prepare a spherical center.

### (2) Center Preparation 2

Pellets of resin compositions for centers were prepared by mixing the raw materials shown in Table 2 with a twin-screw kneading extruder. The extrusion was performed under the following conditions:

screw diameter=45 mm;

screw revolutions=200 rpm; and

screw L/D=35.

Here, the compositions were heated to a temperature ranging from 160° C. to 230° C. in the die of the extruder. Each of the obtained resin compositions for centers was heated to 180° C. to 210° C., and then injected into molds having a hemispherical cavity clamped under a pressure of 80 tons. After a predetermined period of cooling, the mold set was opened to take out the molded center.

TABLE 1
Center materials 1

| Center No. | | A | B |
|---|---|---|---|
| Composition | BR-730 | 100 | 100 |
| | Zinc acrylate | 25 | 30 |
| | Zinc oxide | 5 | 5 |
| | Dicumylperoxide | 0.9 | 0.9 |
| | Diphenyldisulfide | 0.5 | 0.5 |
| | Barium sulfate | Q.S.*⁾ | Q.S.*⁾ |
| Physical properties | Center diameter (mm) | 39.2 | 40.2 |
| | Amount of compression | 4.0 | 3.4 |
| | deformation (mm) | | |
| | Core hardness (Shore D) | 40 | 43 |
| | Surface hardness (Shore D) | 49 | 53 |

Amount: parts by mass
*⁾The amount of barium sulfate was adjusted to provide a golf ball having a mass of 45.4 g.

TABLE 2
Center materials 2

| | | Center No. | | | | | | | | |
|---|---|---|---|---|---|---|---|---|---|---|
| | | C | D | E | F | G | H | I | J | K |
| Composition | HPF 1000 | 100 | 100 | — | — | — | 100 | — | 100 | — |
| | HPF 2000 | — | — | 100 | 100 | 100 | — | 100 | — | 100 |
| | Erucic acid amide | — | — | — | 10 | — | — | — | — | — |
| | Oleic acid amide | — | — | — | — | 20 | — | — | — | — |
| | Stearic acid amide | 30 | 50 | — | — | — | — | — | — | 60 |
| | Ethylenebisstearic acid amide | — | — | 5 | — | — | — | — | 0.3 | — |
| Physical properties | Slab hardness (Shore D) | 45 | 39 | 42 | 39 | 37 | 55 | 45 | 54 | 21 |
| | Rebound resilience (%) | 65 | 63 | 66 | 68 | 67 | 70 | 73 | 69 | 61 |
| | Melt flow rate (g/100 min) | 19 | 31 | 6 | 9 | 12 | 1 | 1 | 10 | 47 |

Amount: parts by mass

### (3) Preparation of Composition for Cover and Composition for Intermediate Layer

Pellets of compositions for intermediate layers and compositions for covers were prepared by mixing the raw materials shown in Tables 3 to 5 with a twin-screw kneading extruder. The extrusion was performed under the following conditions:

screw diameter=45 mm;

screw revolutions=200 rpm; and

screw L/D=35.

Here, the compositions were heated to a temperature ranging from 160° C. to 230° C. in the die of the extruder.

TABLE 3
Intermediate layer materials 1 (ternary ionomer resin)

| | | Intermediate layer No. | | | | | | | |
|---|---|---|---|---|---|---|---|---|---|
| | | 1 | 2 | 3 | 4 | 5 | 6 | 7 | 8 |
| Composition | Himilan AM 7327 | 100 | 100 | 100 | 100 | 80 | 100 | 100 | 100 |
| | NUCREL AN4319 | — | — | — | — | 20 | — | — | — |
| | Erucic acid amide | 5 | — | — | — | — | — | — | — |
| | Oleic acid amide | — | 20 | — | — | 10 | — | 0.1 | 60 |
| | Stearic acid amide | — | — | 30 | — | — | — | — | — |
| | Ethylenebisstearic acid amide | — | — | — | 30 | — | — | — | — |
| Physical properties | Slab hardness (Shore D) | 41 | 34 | 41 | 36 | 33 | 44 | 43 | 20 |
| | Rebound resilience (%) | 45 | 43 | 38 | 33 | 40 | 47 | 46 | 29 |
| | Melt flow rate (g/100 min) | 21 | 11 | 21 | 14 | 18 | 0.7 | 1.0 | 50 |

Amount: parts by mass

TABLE 4
Intermediate layer materials 2 (binary ionomer resin)

| | | Intermediate layer No. | | | | | |
|---|---|---|---|---|---|---|---|
| | | a | b | c | d | e | f |
| Com- | Himilan AM | 100 | 100 | 100 | 90 | 100 | 100 |
| position | 7329 | | | | | | |
| | NUCREL | — | — | — | 10 | — | — |
| | N1050H | | | | | | |
| | Erucic acid amide | 0.3 | — | — | — | — | — |
| | Oleic acid amide | — | 5 | — | 5 | — | — |
| | Stearic acid | — | — | 20 | — | — | — |
| | amide | | | | | | |
| | Ethylenebisstearic | — | — | — | — | 60 | — |
| | acid amide | | | | | | |
| Physical | Slab hardness | 64 | 62 | 58 | 59 | 45 | 64 |
| properties | (Shore D) | | | | | | |
| | Rebound | 51 | 48 | 45 | 46 | 23 | 52 |
| | resilience (%) | | | | | | |
| | Melt flow rate | 9 | 17 | 30 | 20 | 73 | 5 |
| | (g/100 min) | | | | | | |

Amount: parts by mass

TABLE 5
Cover or intermediate layer materials

| | | | |
|---|---|---|---|
| Cover No., intermediate layer No. | x | y | z |

| | | | | |
|---|---|---|---|---|
| Composition | Himilan 1605 | — | 50 | — |
| | Himilan AM 7329 | 70 | 50 | — |
| | NUCREL N1050H | 30 | — | — |
| | Elastollan NY85A | — | — | 100 |
| | Titanium oxide | 4 | 4 | 4 |
| Physical | Slab hardness (Shore D) | 59 | 65 | 32 |
| property | | | | |

Amount: parts by mass

### (4) Preparation of Golf Ball Body

The compositions for intermediate layers obtained above were injection-molded onto the spherical centers obtained above to form intermediate layers covering the respective centers, according to the structures shown in Tables 6 to 8. Thus, spherical cores were prepared. Subsequently, the compositions for covers were injection-molded onto the respective spherical cores to form covers. Thus, golf balls were produced. Upper and lower molds for forming intermediate layers and covers each had a spherical cavity with pimples. A part of the pimples also served as retractable hold pins.

In the case of forming an intermediate layer, the hold pins were protruded and a center was placed in the mold set and held with the hold pins. A composition for an intermediate layer was heated to 260° C. and injected into the mold clamped under a pressure of 80 tons in 0.3 seconds, and then cooled for 30 seconds. Then, the mold was opened to take out the molded core.

In the case of forming a cover, the hold pins were protruded and a core was placed in the mold set and held with the hold pins. A resin heated to 210° C. was injected into the mold clamped under a pressure of 80 tons in 0.3 seconds, and cooled for 30 seconds. Then, the mold was opened to take out the molded golf ball. Golf ball bodies thus obtained were surface-treated by sandblasting, and subjected to marking and then painting with a clear paint. The paint was dried in an oven at 40° C., and the resulting golf balls had a diameter of 42.8 mm and a mass of 45.4 g. The golf balls were evaluated for the amount of compression deformation, coefficient of restitution, and shot feeling. The results are shown in Tables 6 to 8.

TABLE 6

| | | | Golf ball No. | | | | | | | |
|---|---|---|---|---|---|---|---|---|---|---|
| | | | 1 | 2 | 3 | 4 | 5 | 6 | 7 | 8 |
| Golf ball | Structure | Center No. | A | A | A | A | A | A | A | A |
| | | (diameter: 39.2 mm) | | | | | | | | |
| | | Intermediate layer No. | 1 | 2 | 3 | 4 | 5 | 6 | 7 | 8 |
| | | (thickness: 0.8 mm) | | | | | | | | |
| | | Cover No. | x | x | x | x | x | x | x | x |
| | | (thickness: 1 mm) | | | | | | | | |
| | Physical properties | Amount of compression | 3.30 | 3.50 | 3.30 | 3.45 | 3.65 | 3.20 | 3.22 | 3.80 |
| | | deformation (mm) | | | | | | | | |
| | | Coefficient of restitution | 99.9 | 99.8 | 99.7 | 99.6 | 99.7 | 100 | 100 | Crack |
| | | (index) | | | | | | | | |
| | | Shot feeling | Good | Good | Good | Good | Good | Poor | Fair | Crack |

The coefficients of restitution are indice based on that of golf ball No. 6 defined as 100.0.

TABLE 7

| | | | Golf ball No. | | | | | |
|---|---|---|---|---|---|---|---|---|
| | | | 9 | 10 | 11 | 12 | 13 | 14 |
| Golf ball | Structure | Center No. | B | B | B | B | B | B |
| | | (diameter: 40.2 mm) | | | | | | |
| | | Intermediate layer No. | a | b | c | d | e | f |
| | | (thickness: 0.8 mm) | | | | | | |
| | | Cover No. | z | z | z | z | z | z |
| | | (thickness: 0.5 mm) | | | | | | |
| | Physical properties | Amount of compression | 3.01 | 3.04 | 3.09 | 3.10 | Crack | 3.02 |
| | | deformation (mm) | | | | | | |
| | | Coefficient of restitution | 100.0 | 99.9 | 99.7 | 99.8 | Crack | 100 |
| | | (index) | | | | | | |
| | | Shot feeling | Poor | Fair | Good | Good | Crack | Poor |

The coefficients of restitution are indice based on that of golf ball No. 14 defined as 100.0.

TABLE 8

| | | | Golf ball No. | | | | | | | | |
|---|---|---|---|---|---|---|---|---|---|---|---|
| | | | 15 | 16 | 17 | 18 | 19 | 20 | 21 | 22 | 23 |
| Golf ball | Structure | Center No. | C | D | E | F | G | H | I | J | K |
| | | (diameter: 39.8 mm) | | | | | | | | | |
| | | Intermediate layer No. | y | y | y | y | y | y | y | y | y |
| | | (thickness: 1 mm) | | | | | | | | | |
| | | Cover No. | z | z | z | z | z | z | z | z | z |
| | | (thickness: 0.5 mm) | | | | | | | | | |
| | Physical | Amount of compression | 2.35 | 3.45 | 3.01 | 3.45 | 3.64 | 1.20 | 2.32 | 1.24 | Crack |
| | properties | deformation (mm) | | | | | | | | | |
| | | Coefficient of restitution | 99.8 | 99.5 | 99.7 | 99.7 | 99.6 | 100 | 99.8 | 99.9 | Crack |
| | | (index) | | | | | | | | | |
| | | Shot feeling | Good | Good | Good | Good | Good | Poor | Fair | Poor | Crack |

The coefficients of restitution are indice based on that of golf ball No. 20 defined as 100.0.

The raw materials shown in Tables 1 to 5 are as follows.

BR-730: “BR730 (high-cis polybutadiene)” manufactured by JSR Corp.

Zinc acrylate: “ZNDA-90S” manufactured by NIHON JYORYU KOGYO CO., LTD.

Zinc oxide: “Ginrei (registered trademark) R” manufactured by Toho Zinc Co., Ltd.

Dicumyl peroxide: “Percumyl (registered trademark) D” manufactured by NOF Corp.

Diphenyl disulfide: product of Sumitomo Seika Chemicals Co., Ltd.

Barium sulfate: “Barium Sulfate BD” manufactured by Sakai Chemical Industry Co., Ltd.

Himilan AM 7327: zinc ion-neutralized ethylene-methacrylic acid-butyl acrylate ternary copolymer ionomer resin manufactured by Du Pont-Mitsui Polychemicals Co., Ltd. (melt flow rate (190° C./2.16 kg): 0.7 g/10 min, Shore D hardness: 44)

Himilan AM 7329: zinc ion-neutralized ethylene-methacrylic acid binary copolymer ionomer resin manufactured by Du Pont-Mitsui Polychemicals Co., Ltd. (melt flow rate (190° C./2.16 kg): 5 g/10 min, Shore D hardness: 61)

Himilan 1605: sodium ion-neutralized ethylene-methacrylic acid copolymer ionomer resin manufactured by Du Pont-Mitsui Polychemicals Co., Ltd. (melt flow rate (190° C./2.16 kg): 2.8 g/10 min, Shore D hardness: 65)

NUCREL AN4319: ethylene-methacrylic acid-butyl acrylate copolymer manufactured by Du Pont-Mitsui Polychemicals Co., Ltd. (melt flow rate (190° C./2.16 kg): 55 g/10 min)

NUCREL N1050H: ethylene-methacrylic acid copolymer manufactured by Du Pont-Mitsui Polychemicals Co., Ltd. (melt flow rate (190° C./2.16 kg): 500 g/10 min)

HPF 1000: magnesium ion-neutralized ethylene-acrylic acid-butyl acrylate ternary copolymer ionomer resin manufactured by Du Pont (melt flow rate (190° C./2.16 kg): 1.0 g/10 min, Shore D hardness: 55D)

HPF 2000: magnesium ion-neutralized ethylene-acrylic acid-butyl acrylate ternary copolymer ionomer resin manufactured by Du Pont (melt flow rate (190° C./2.16 kg): 1.0 g/10 min, Shore D hardness: 45D)

Elastollan NY85A: polyurethane manufactured by BASF (hardness: 85A)

Erucic acid amide: product of Tokyo Chemical Industry Co., Ltd.

Oleic acid amide: product of Tokyo Chemical Industry Co., Ltd.

Stearic acid amide: product of Tokyo Chemical Industry Co., Ltd.

Ethylenebisstearic acid amide: product of Tokyo Chemical Industry Co., Ltd.

Titanium oxide: “A-220” manufactured by ISHIHARA SANGYO KAISHA, LTD.

As seen in Tables 2 to 4, when the materials containing a predetermined amount of a fatty acid amide had significantly improved fluidity while maintaining good resilience performance. As seen in Tables 6 and 7, the golf balls including an intermediate layer formed of the material containing a predetermined amount of a fatty acid amide had good resilience performance and also gave an excellent shot feeling due to flexibility of the material. Table 8 shows that the same effect was likewise obtained when such materials were used for centers.

### INDUSTRIAL APPLICABILITY

The present invention provides a resin composition for a golf ball which has excellent resilience performance and fluidity. In addition, by using the resin composition, it is possible to provide a golf ball that gives an excellent shot feeling and has excellent resilience performance.

1. A resin composition for a golf ball comprising:
(A) a resin component containing at least one selected from the group consisting of (a-1) a binary copolymer of an olefin and an α,β-unsaturated carboxylic acid having 3 to 8 carbon atoms, (a-2) a metal ion-neutralized product of a binary copolymer of an olefin and an α,β-unsaturated carboxylic acid having 3 to 8 carbon atoms, (a-3) a ternary copolymer of an olefin, an α,β-unsaturated carboxylic acid having 3 to 8 carbon atoms, and an α,β-unsaturated carboxylic acid ester, and (a-4) a metal ion-neutralized product of a ternary copolymer of an olefin, an α,β-unsaturated carboxylic acid having 3 to 8 carbon atoms, and an α,β-unsaturated carboxylic acid ester; and
(B) a fatty acid amide, the fatty acid amide being present in an amount of 5 to 50 parts by mass per 100 parts by mass of the resin component.

2. The resin composition for a golf ball according to claim 1,
wherein the fatty acid amide has 8 to 60 carbon atoms.

3. The resin composition for a golf ball according to claim 1,
wherein the fatty acid amide is at least one of a saturated fatty acid amide and an unsaturated fatty acid amide.

4. The resin composition for a golf ball according to claim 1,
wherein the fatty acid amide is at least one of a monoamide and a bisamide.

5. The resin composition for a golf ball according to claim 1,
wherein the fatty acid amide is at least one selected from the group consisting of decanoic acid amide, lauric acid amide, stearic acid amide, behenic acid amide, oleic acid amide, erucic acid amide, ethylenebisstearic acid amide, and ethylenebisoleic acid amide.

6. The resin composition for a golf ball according to claim 1,
wherein the resin composition for a golf ball has a slab hardness ranging from 15 to 70 in Shore D hardness.

7. The resin composition for a golf ball according to claim 1, wherein the fatty acid amide is represented by the following formula (1):
R¹—CO—NH—R² (1)
wherein R¹ and R², which may be the same or different, are each a saturated or unsaturated aliphatic hydrocarbon group having 8 to 30 carbon atoms, R² may be hydrogen, and part of the hydrogen atoms of R¹ and R² may be substituted by hydroxyl groups.

8. The resin composition for a golf ball according to claim 1, wherein the fatty acid amide is represented by the following formula (2) or (3):
R³—CO—NH-A¹—NH—CO—R⁴ (2)
R⁵—NH—CO-A²-CO—NH—R⁶ (3)
wherein R³, R⁴, R⁵, and R⁶, which may be the same or different, are each a saturated or unsaturated aliphatic hydrocarbon group having 8 to 30 carbon atoms, and A¹ and A², which may be the same or different, are each an alkylene group having 1 to 10 carbon atoms, a phenylene group, or an alkylphenylene group having 7 to 10 carbon atoms (divalent hydrocarbon group), wherein in the case of the alkylphenylene group, the group may be a divalent hydrocarbon group formed by combining a phenylene group and two or more groups selected from alkyl groups and alkylene groups; and part of the hydrogen atoms of the hydrocarbon groups of R³, R⁴, R⁵, R⁶, A¹, and A² may be substituted by hydroxyl groups.

9. The resin composition for a golf ball according to claim 7, wherein the fatty acid amide is a monoamide of formula (1) wherein R¹ is a saturated or unsaturated aliphatic hydrocarbon group and R² is hydrogen.

10. The resin composition for a golf ball according to claim 7, wherein the fatty acid amide is a monoamide of formula (1) wherein R¹ is an unsaturated aliphatic hydrocarbon group and R² is hydrogen.

11. The resin composition for a golf ball according to claim 1, wherein the resin composition for a golf ball has a melt flow rate (190° C./2.16 kg) of at least 0.01 g/10 min but not more than 100 g/10 min.

12. The resin composition for a golf ball according to claim 1, wherein the resin composition for a golf ball has a rebound resilience of not less than 25%.

13. A golf ball comprising
a member made from the resin composition for a golf ball according to claim 1.

14. A golf ball comprising:
a core including one or more layers; and
a cover covering t
wherein at least one of the layers of the core is made from the resin composition for a golf ball according to claim 1.

15. A multi-piece golf ball comprising:
a core including a center and one or more intermediate layers covering the center; and
a cover covering the core,
wherein at least one of the intermediate layers is made from the resin composition for a golf ball according to claim 1.

16. A one-piece golf ball comprising
a golf ball body made from the resin composition for a golf ball according to claim 1.
